(19) United States
(12) Patent Application Publication
(10) Pub. No.: US 2001/0053802 A1
(43) Pub. Date: Dec. 20, 2001

(54) Insulating composition that is resistant to oil and to fire propagation, and a method of preparing it

(75) Inventor: Gilles Chriqui, Villeurbanne (FR)

Correspondence Address: SUGHRUE, MION, ZINN, MACPEAK & SEAS, PLLC, 2100 Pennsylvania Avenue, N.W., Suite 800, Washington, DC, 20037-3213, US

(73) Assignee: NEXANS (FRANCE)

(21) Appl. No.: 09/881,702

(22) Filed: Jun. 18, 2001

(30) Foreign Application Priority Data
Jun. 19, 2000 (FR) 00 07 791

(51) Int. Cl. C09K 21/14; C08K 3/26

(52) U.S. Cl. 523/179; 524/425

(57) ABSTRACT

The composition includes a chlorinated polyolefin grafted by an amino-silane to enable it to be cured in air. The composition contains a basic mixture including, for 100 parts by weight of said chlorinated polyolefin, 100 to 250 parts of a filler containing moisture and an agent for treating said filler, and said amino-silane is grafted to said chlorinated polyolefin of said basic mixture during extrusion of the composition. The composition is useful in insulating and sheathing cables.

The present invention relates to insulating compositions that are resistant to oil and to fire propagation, that are extrudable and curable, and that are intended in particular for the cable-making industry. The invention also relates to methods of preparing, and in particular of curing such compositions.

### BACKGROUND OF THE INVENTION

The compositions with which the invention is concerned are more particularly compositions that comply with European harmonization standard CENELEC HD22.1 S 3, categories EM2 and EM7, and other equivalent specifications or standards relating to resistance to oil and to flame, and suitable for constituting the insulating covering or sheathing on relatively flexible electrical conductors, and more particularly cables for equipment and for manufacturers.

Document FR-A-2 419 957 discloses a polymeric composition that is resistant to oil and to fire, comprising an ethylene vinyl acetate copolymer (EVA), a chlorinated polyethylene (CPE), and hydrated alumina. That composition contains 10 to 50 parts of CPE and 70 to 300 parts of hydrated alumina, per 100 parts by weight of EVA, the EVA copolymer containing 20% to 90% by weight vinyl acetate (VA). It also includes a silane type adhesion agent that must not impede curing of the composition and that must not degrade while it is being transformed. The composition is cured chemically or by irradiation. For this purpose, it includes a peroxide curing agent.

To prepare the composition, that document teaches mixing the various components together vigorously, with the exception of the curing agent, while raising the temperature to about 121° C. The temperature is then lowered to below about 113° C. and the peroxide is added, while continuing to mix until the composition is uniform. The composition is then transformed, extruded on a wire, and cured in a steam tube or in an autoclave.

The wire insulated in this way is relatively stiff, in particular because of the presence of EVA used in combination with CPE and hydrated alumina, for obtaining the required properties in the extruded and cure composition. Furthermore, that composition is lengthy to prepare and its method of curing is expensive and inconvenient.

Other known compositions which are insulating and resistant to oil and to flame propagation are based on chlorinated polyolefins, and more particularly on CPE, which are silane-grafted for curing purposes.

Thus, documents JP-A-57 008 203 and FR-A-2 618 152 disclose a method of grafting a chlorinated polyolefin, in particular CPE, by means of an amino-silane so as to enable it to be cured in air or in contact with water in the presence of a catalyst for condensing/hydrolyzing silanols.

To enable CPE to be silane-grafted under satisfactory conditions, document FR-A-2 618 152 also discloses performing the grafting in the presence of an acid acceptor at a temperature lying in the range 150° C. to 200° C. The acid acceptor is selected from basic salts of heavy metals, such as lead, barium, and cadmium.

In that document FR-A-2 618 152, the method of silane grafting and curing CPE can be performed in one or two stages. In the one-stage method, the liquid agents such as the amino silane and the catalyst are mixed together, and then the liquid mixture is added to the other ingredients, in particular the CPE and the acid acceptor, in a powder mixer so as to obtain a uniform mixture which is then loaded into the hopper of a conventional extruder. In the two-stage method, the ingredients are stored in the form of two separate components, firstly the amino-silane grafted CPE and secondly the catalyst. When curing is to be performed, the catalyst mixed with CPE of the same kind as the grafted CPE but not modified by grafting, is added to the grafted CPE under the same conditions as for preparation by the single-stage method.

The performance of these compositions based on silane-grafted CPE is often unsatisfactory. In addition, industrializing the method of preparation is difficult and awkward. In particular, the single-stage preparation method gives rise to the extruder becoming clogged frequently, while the two-stage method gives rise to the possibility of the grafted CPE curing partially while it is in storage. Furthermore, the final cured composition is relatively expensive.

### OBJECTS AND SUMMARY OF THE INVENTION

An object of the present invention is to obtain a formulation of curable compositions including a chlorinated polyolefin that avoids the drawbacks of the above-mentioned known compositions.

The invention provides an extrudable and curable insulating composition that is resistant to oil and to propagating fire, the composition comprising a chlorinated polyolefin and a curing amino-silane, and comprising a basic mixture containing said chlorinated polyolefin, and for 100 parts by weight thereof, 100 to 250 parts by weight of a mineral filler containing moisture and an agent for treating said filler by reacting with the moisture contained therein, an said amino-silane.

Advantageously, the content by weight of said filler in the composition is 1.4 to 1.7 times the content of the chlorinated polyolefin.

The treatment agent of the filler is selected to react with the moisture contained therein, by making it less hydrophilic and thus making it possible to improve the mechanical performance of the composition. This treatment agent is constituted in particular by a hydrolizable silane compound which is inert or reacts very little with the chlorinated polyolefin so as to cure it very little or not at all. It represents 0.5 to 5 parts by weight per 100 parts by weight of said filler.

The filler is preferably based on chalk, or it can be based on hydrated alumina. Most advantageously, it also includes an antimony compound, in particular antimony oxide having the formula Sb₂O₃ which gives a reinforced flame-resistant effect to the filler associated with the chlorinated polyolefin, in conjunction with likewise-improved mechanical properties in the final cured composition. The quantity of this antimony compound constitutes 2% to 7% of the total weight of said filler.

### DETAILED DESCRIPTION OF THE INVENTION

In order to prepare the composition, the chlorinated polyolefin, said filler, said filler treatment agents, and other common additives, in particular such as plasticizers, lubricants, anti-oxidizers, and agents for providing resistance against UV radiation, are all mixed together in an internal mixer or a continuous mixer while heating is applied so as to obtain a uniform basic mixture. The temperature of this basic mixture, once uniform, reaches 130° C. The basic mixture obtained in this way is then unloaded and transformed by passing over a cold cylinder, cutting up, and granulating, so as to be stored until it is used, i.e. until it is extruded on a cable and cured. Extrusion is performed using a conventional extruder, having a typical profile of 90° C. to 145° C., with an amino-silane and a silanol condensation catalyst being added to the basic mixture, directly in the hopper of the extruder.

The amino-silane reacts directly with the chlorinated polyolefin, without being deactivated in any way by the filler whose moisture content is very low in the basic mixture, so as to be grafted to said chlorinated polyolefin without giving off hydrochloric acid as a result thereof, and then the extruded composition is cured in air.

The quantity of amino-silane added is 0.8 to 4 parts by weight per 100 parts of said basic mixture. The silanol condensation catalyst, in particular a tin salt, constitutes 0.01 to 0.1 parts by weight per 100 parts of said basic mixture.

This addition of amino-silane and catalyst to the basic mixture takes place by using a master mixture constituted by an auxiliary polymeric compound, which contains these initially-liquid ingredients but which nevertheless remains in solid form. Such an auxiliary polymeric compound is easy to mix uniformly with the basic mixture, thus ensuring that the amino-silane and the catalyst are diffused uniformly throughout the basic mixture and grafting takes place uniformly in the extruder, followed by the chlorinated polyolefin curing in air. The auxiliary polymeric polymer is, in particular, a porous or swelling or encapsulating polymer having high capacity to absorb or adsorb silane. For example it is a porous polyethylene that reacts very little or not at all with amino-silane and that contains at least its own weight thereof.

In a variant, this addition of amino-silane and catalyst is performed by injecting the liquid ingredients into the hopper of the extruder onto the master mixture to which an auxiliary polymer is then added capable of absorbing the injected liquid ingredients almost instantaneously. By way of example, such an auxiliary polymer is a “finished” porous polymer which is presented in the form of granules but which is subsequently treated mechanically so as to increase sufficiently the rate at which it adsorbs liquid ingredients brought into contact therewith, or a “unfinished” porous polymer such as that known as Spherilene. It retains the liquids injected directly into the hopper of the extruder and diffuses them uniformly throughout the basic mixture and the chlorinated polyolefin of said basic mixture, and then grafts said chlorinated polyolefin uniformly in the extruder, and then causes it to cure in air.

The composition of the present invention and the method of preparing it provides numerous advantages, and in particular:

it can be formulated in the form of a basic mixture in a manner that is simple and fast;

the composition is of moderate cost because of the large amount of filler it contains;

extrusion takes place using a conventional extruder; and

cables provided with insulating or sheathing made using this composition are lighter in weight, flexible, and less expensive, while also providing resistance to oil and to fire that satisfy the requirements of standards that are particularly severe.

Tests have been performed that show that the composition of the invention has the following properties:

ultimate tensile strength: 11 MPa;

breaking elongation: 390%;

hot creep at 200° C. under stress of 0.2 MPa for 15 minutes:

elongation under stress: 35%;

remanent deformation after stress: 5%;

resistance to IRM 902 mineral oil over 24 hours at 100° C.:

change in ultimate tensile strength: −20%;

change in breaking elongation: ≈0%;

aging in an oven for 7 days at 120° C.:

change in ultimate tensile strength: −15%;

change in breaking elongation: +15%.

1. An extrudable and curable insulating composition that is resistant to oil and to propagating fire, the composition comprising a chlorinated polyolefin and a curing amino-silane, and comprising a basic mixture containing said chlorinated polyolefin, and for 100 parts by weight thereof, 100 to 250 parts by weight of a mineral filler containing moisture and an agent for treating said filler by reacting with the moisture contained therein, an said amino-silane.

2. A composition according to claim 1, wherein said agent for treating said filler is a silane compound that is substantially inert relative to said chlorinated polyolefin.

3. A composition according to claim 2, including 0.5 to 5 parts by weight of said treatment agent per 100 parts by weight of said filler.

4. A composition according to claim 1, wherein said filler is based on chalk.

5. A composition according to claim 1, wherein said filler includes an antimony compound, constituting 2% to 10% of the total weight of said filler.

6. A composition according to claim 1, including an auxiliary polymeric compound for temporarily retaining and diffusing at least said amino-silane throughout said composition.

7. A composition according to claim 6, wherein said auxiliary polymeric compound is selected from polymers suitable for containing at least said amino-silane while remaining in solid form, and those suitable for adsorbing at least said amino-silane almost instantaneously.

8. A composition according to claim 1, wherein its content by weight of said filler is 1.4 to 1.7 times its content by weight of the chlorinated polyolefin.

9. A method of preparing the composition according to claim 1, consisting in mixing the following together while heating them: said chlorinated polyolefin, said filler, and said treatment agent, thereby obtaining said basic mixture which has been made uniform and then transformed, and in adding said amino-silane to said transformed basic mixture during extrusion thereof.

10. A method according to claim 9, wherein said basic mixture is made at a temperature rising to about 130° C.

11. A method according to claim 9, consisting in mixing said transformed basic mixture and a solid auxiliary polymeric compound containing said amino-silane, in an extruder hopper.

12. A method according to claim 9, consisting in injecting said amino-silane onto said transformed basic mixture having an auxiliary polymeric compound added thereto which adsorbs said injected amino-silane almost instantaneously, in an extruder hopper.

13. A method according to claim 9, wherein said composition is extruded at a temperature in the range 90° C. to 145° C.
